(19) United States
(12) Patent Application Publication
(10) Pub. No.: US 2024/0158305 A1
(43) Pub. Date: May 16, 2024

(54) ARTICLE CONTAINING SILICON CARBIDE AS MAIN COMPONENT, AND METHOD OF MANUFACTURING THE SAME

(71) Applicant: CANON KABUSHIKI KAISHA, Tokyo (JP)

(72) Inventor: MOTOKI OKINAKA, Tokyo (JP)

(21) Appl. No.: 18/391,322

(22) Filed: Dec. 20, 2023

Related U.S. Application Data
(63) Continuation of application No. PCT/JP2022/025909, filed on Jun. 29, 2022.

(30) Foreign Application Priority Data
Jun. 30, 2021 (JP) 2021-109343
Jun. 28, 2022 (JP) 2022-103101

(51) Int. Cl. C04B 35/565; C04B 41/00; C04B 41/84

(52) U.S. Cl. CPC C04B 35/565; C04B 41/0036; C04B 41/0072; C04B 41/84; C04B 2235/3826; C04B 2235/483; C04B 2235/665

(57) ABSTRACT

A method of manufacturing an article containing silicon carbide as a main component includes a step of laying raw material powder, and a step of irradiating the raw material powder with a laser beam, wherein the raw material powder contains 95 mol % or more of silicon carbide, and wherein, in the step of irradiating the raw material powder with the laser beam, the raw material powder is irradiated with the laser beam to decompose the silicon carbide in at least a part of an irradiation portion of the laser beam into silicon and carbon and to turn the silicon or the carbon into melt.

### CROSS-REFERENCE TO RELATED APPLICATIONS

This application is a Continuation of International Patent Application No. PCT/JP2022/025909, filed Jun. 29, 2022, which claims the benefit of Japanese Patent Applications No. 2021-109343, filed Jun. 30, 2021, and No. 2022-103101, filed Jun. 28, 2022, all of which are hereby incorporated by reference herein in their entirety.

### BACKGROUND OF THE INVENTION

### Field of the Invention

The present invention relates to a technique for manufacturing an article containing silicon carbide as a main component by powder bed fusion using raw material powder containing silicon carbide as a main component.

### Background Art

As a method of manufacturing an article having a complicated shape or a wide variety of articles in small quantities, so-called 3D printing that is additive manufacturing in which raw metal powder is irradiated with a laser beam based on three-dimensional data of an article to be manufactured, to fabricate an article, is increasingly used. Further, in recent years, an attempt of applying the additive manufacturing to manufacture of an article made of an inorganic compound material difficult to be processed, such as silicon carbide and TiAl has progressed.

Patent Literature 1 discusses a method of fabricating an article containing silicon carbide as a main component by powder bed fusion using powder containing silicon carbide particles and molding resin particles such as particles of nylon, polypropylene, and polyethylene terephthalate. Patent Literature 2 discusses a method of performing fabrication by using powder containing silicon carbide and a metal boride having a melting point lower than a melting point of silicon carbide.

In a process in which the silicon carbide particles and the molding resin particles are mixed and used for fabrication as discussed in Patent Literature 1, a step of degreasing the molding resin is finally necessary. In the degreasing step, the resin component is removed, and a fabricated object is accordingly contracted by the removed resin component. To obtain the fabricated object having a desired dimension, a user is required to have high proficiency. In the method discussed in Patent Literature 2, the fabrication can be performed while decomposition of silicon carbide is suppressed by addition of the metal boride. Therefore, a fabricated object relatively high in accuracy can be obtained irrespective of proficiency of the user. However, there is an issue that a fabrication cost is high because metal boride powder is more expensive than silicon carbide powder.

### CITATION LIST

### Patent Literature

PTL 1: Japanese Patent Application Laid-Open No. 2017-171577

PTL 2: Japanese Patent Application Laid-Open No. 2019-64226

### SUMMARY OF THE INVENTION

According to a first aspect of the present invention, a method of manufacturing an article containing silicon carbide as a main component includes a step of laying raw material powder, and a step of irradiating the raw material powder with a laser beam, wherein the raw material powder contains 95 mol % or more of silicon carbide, and wherein, in the step of irradiating the raw material powder with the laser beam, the raw material powder is irradiated with the laser beam to decompose the silicon carbide in at least a part of an irradiation portion of the laser beam into silicon and carbon and to turn the silicon or the carbon into melt.

According to a second aspect of the present invention, an article containing silicon carbide as a main component includes a region where a composition ratio of silicon, carbon, and silicon carbide changes in one direction.

Further features of the present invention will become apparent from the following description of exemplary embodiments with reference to the attached drawings.

### BRIEF DESCRIPTION OF THE DRAWINGS

FIG. 1 is a schematic view of an apparatus according to the present invention.

FIG. 2A is a diagram illustrating a laser beam irradiation order according to an existing technique.

FIG. 2B is a diagram illustrating a laser beam irradiation order according to the present invention.

FIG. 3A is a diagram illustrating a focus position of a laser beam.

FIG. 3B is a diagram illustrating light intensity distribution at the focus position and a defocus position of the laser beam.

FIG. 4 is a diagram illustrating a state where irradiation with the laser beam in a defocus state is performed in fabrication.

FIG. 5 is a diagram illustrating relationship between a depth from a surface of a fabricated object and peak intensity of silicon carbide in Raman spectroscopy.

### DESCRIPTION OF THE EMBODIMENTS

In powder bed fusion, a step of laying raw material powder over a fabrication surface, and then melting and solidifying the powder by irradiation with a laser beam is repeated a plurality of times to fabricate a three-dimensional object. Therefore, the raw material powder is required to have property in which at least a part of the raw material powder is melted by irradiation with the laser beam.

Silicon carbide is a material that is thermally decomposed into silicon and carbon at a temperature of 2830° C. or more and sublimes at a temperature near 3600° C., and does not have a temperature range where silicon carbide is in a liquid phase. Therefore, it has been considered that it is impossible to perform fabrication by the powder bed fusion using silicon carbide powder not containing an organic or inorganic binder, as a raw material. However, the silicon carbide powder is thermally decomposed into silicon and carbon within a temperature range of 2830° C. or more and less than 3600° C., and at least a part of the thermally decomposed silicon or carbon is present in a state of melt.

In the powder bed fusion, the powder is irradiated with the scanning laser beam, and the powder is melted for a time of millisecond order and then solidified to form a solidified portion. The present inventors found a method of forming the solidified portion using melted silicon or carbon as a binder by controlling such laser beam irradiation for a short time to decompose silicon carbide into silicon and carbon and to turn at least one of silicon and carbon into melt. The method enables fabrication without adding an organic or inorganic binder to the silicon carbide powder.

A temperature at which silicon carbide is thermally decomposed into silicon and carbon, and silicon or carbon is turned into melt is 2380° C. or more and less than 3600° C. Therefore, when the temperature of the silicon carbide powder is controlled to the temperature range, fabrication can be performed by using silicon melt or carbon melt as the binder. At a temperature less than 2830° C., silicon carbide is not thermally decomposed, and thus silicon melt and carbon melt are not generated. At a temperature greater than or equal to 3600° C., it is difficult to perform fabrication because silicon carbide sublimes. A decomposition point and a boiling point of silicon carbide are changed depending on purity of the silicon carbide powder and a type of an additive. In a case of using powder containing 95 mol % or more of silicon carbide, irradiation energy of the laser beam is preferably controlled so as to increase the temperature of the powder to 2830° C. or more and less than 3600° C. At this time, fabrication can be performed at the temperature of 2830° C. or more and less than 3600° C. even though a boiling point of silicon is about 2600° C. The estimated reason is that an irradiation time of the laser beam is millisecond order, and the temperature reaches 2830° C. or more and less than 3600° C. in an extremely short time, and accordingly, solidification starts at the same time when evaporation of silicon starts, which suppresses evaporation of silicon.

To control a temperature of a laser beam irradiation portion in the powder bed fusion, control of output power of the laser beam, a scanning speed of the laser beam, a scanning interval of the laser beam, and a thickness of the powder is important. The present inventors examined conditions enabling stable thermal decomposition of silicon carbide to turn silicon or carbon into melt, about discrete irradiation with the laser beam, a defocus amount of the laser beam, and auxiliary heating temperature of the powder and the fabricated object, in addition to these parameters. The discrete irradiation with the laser beam indicates a method of previously dividing an irradiation region into rectangular sections, and discretely irradiating the rectangular sections with the laser beam.

In the following, after a schematic configuration of a fabrication apparatus and a basic fabrication process are described, a method of manufacturing an article containing silicon carbide as a main component by using silicon carbide powder will be described. In the present invention, the main component indicates a component occupying 90 mol % or more of all components.

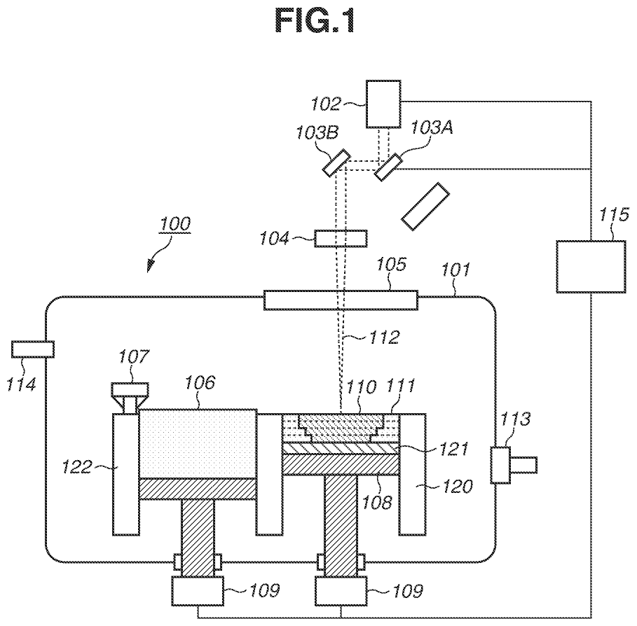

FIG. 1 illustrates an outline of a fabrication apparatus 100 used for the powder bed fusion. The fabrication apparatus 100 includes a chamber 101 provided with a gas introduction port 113 and an exhaust port 114, introduces gas from the gas introduction port 113 and exhausts air from the exhaust port 114, thereby controlling an atmosphere inside the chamber. A pressure control mechanism such as a butterfly valve may be connected to the exhaust port 114 in order to control pressure, or a configuration (generally referred to as blow displacement) that can supply gas and adjust the atmosphere inside the chamber caused by pressure increase with supply of the gas may be connected to the exhaust port 114. FIG. 1 illustrates an example of the fabrication apparatus, and the fabrication apparatus is not limited thereto and can be appropriately deformed.

The chamber 101 internally includes a fabrication container 120 for fabricating a three-dimensional object, and a powder container 122 containing raw material powder (hereinafter, simply referred to as powder in some cases) 106. Positions of bottom parts of the fabrication container 120 and the powder container 122 in a vertical direction can be changed by respective lifting mechanisms 109. The bottom part of the fabrication container 120 also functions as a fabrication stage 108 on which a base plate 121 can be placed.

Raw material powder contained in the powder container 122 is conveyed to the fabrication container 120 by a powder laying mechanism 107, and is laid over the base plate 121 placed on the fabrication stage 108. Moving directions and moving amounts of the lifting mechanisms 109 are controlled by a control unit 115 based on a thickness of the raw material powder laid over the base plate 121. In consideration of fabrication accuracy, positional accuracy of the lifting mechanisms 109 is desirably 1 μm or less.

The control unit 115 is a computer controlling operation of the fabrication apparatus 100, and internally includes a central processing unit (CPU), a read-only memory (ROM), a random access memory (RAM), and an input/output (I/O) port. The ROM stores operation programs of the fabrication apparatus 100. The I/O port is connected to an external apparatus or a network, and can input/output, for example, data necessary for fabrication from/to an external computer. The data necessary for fabrication includes information on the raw material powder and slice data. The slice data may be received from the external computer. Alternatively, shape data on a three-dimensional model to be fabricated may be acquired, the CPU of the control unit 115 may create the slice data, and the created slice data may be stored in the RAM. The slice data is obtained by slicing the shape data on the three-dimensional model to be fabricated in one direction, and is data for performing irradiation with a laser beam 112 based on a cross-sectional shape of the three-dimensional model.

The powder laying mechanism 107 is movable in a horizontal direction, and includes at least one of a squeegee and a roller to convey the raw material powder 106 from the powder container 122 to the fabrication container 120 and to evenly lay the raw material powder 106 to a thickness corresponding to one layer of the slice data. To enhance density of a fabricated object, the powder laying mechanism 107 preferably includes both the squeegee and the roller, and preferably pressurizes the raw material powder 106 by the roller after adjusting the thickness of the raw material powder 106 by the squeegee. In the following, for convenience, the raw material powder 106 evenly laid to the thickness corresponding to one layer of the slice data is referred to as a “powder layer”.

The fabrication apparatus 100 includes a laser beam source 102 for melting the laid raw material powder 106, scanning mirrors 103A and 103B for scanning with the laser beam 112 in two axes, and an optical system 104 for condensing the laser beam 112 to an irradiation portion. The laser beam 112 is emitted from outside of the chamber 101. Therefore, the chamber 101 includes an introduction window 105 for introducing the laser beam 112 to the inside. Various kinds of parameters regarding the laser beam 112 are controlled by the control unit 115. Positions of the fabrication container 120 and the optical system 104 are preferably adjusted in advance such that the laser beam has a desired beam diameter on a surface of the laid raw material powder 106. The beam diameter on the surface of the laid raw material powder 106 is preferably 30 μm or more and 100 μm or less because the beam diameter influences fabrication accuracy.

As the scanning mirrors 103A and 103B, galvanometer mirrors can be suitably used. The galvanometer mirrors are desirably made of a material having a light weight and a low linear expansion coefficient because the galvanometer mirrors are operated at high speed while reflecting the laser beam.

A yttrium aluminum garnet (YAG) laser high in versatility is often used as the laser beam source 102, but a CO₂ laser, a semiconductor laser, or the like may be used. A driving system of the laser beam source 102 may be a pulse system or a continuous irradiation system. As the laser beam 112, a light beam having a wavelength corresponding to an absorption wavelength of the raw material powder 106 is preferably selected. As the laser beam 112, a light beam having a wavelength at which the raw material powder 106 has an absorption rate of 50% or more is preferably used, and a light beam having a wavelength at which the raw material powder 106 has an absorption rate of 80% or more is more preferably used.

As necessary, a heating mechanism for heating the powder around the laser beam irradiation portion is preferably provided. The heating mechanism may be, for example, a heater provided on the fabrication container 120 or a laser beam source provided separately from the laser beam source 102.

Subsequently, the basic fabrication process by the powder bed fusion will be described.

First, the base plate 121 is placed on the fabrication stage 108, and the inside of the chamber 101 is replaced with inert gas such as nitrogen and argon. After replacement of the atmosphere inside the chamber 101 is completed, a powder layer is formed on a fabrication surface of the base plate 121 by the powder laying mechanism 107. As described above, the thickness of the powder layer is determined based on a slice pitch of the slice data generated from the shape data on the three-dimensional model to be fabricated. The fabrication surface indicates a surface on which a new powder layer is formed.

The powder layer is scanned with the laser beam 112 based on the slice data, and the raw material powder 106 in a region corresponding to the cross-sectional shape of the three-dimensional model is irradiated with the laser beam. The region irradiated with the laser beam 112 becomes a solidified portion 110 after the powder 106 is melted and then solidified, whereas a region not irradiated with the laser beam 112 becomes an unsolidified portion 111 in a powder state.

After irradiation with the laser beam, the control unit 115 controls the lifting mechanisms 109 to lower the fabrication stage 108 and to raise the bottom part of the powder container 122. Thereafter, the powder laying mechanism 107 conveys the raw material powder 106 in the powder container 122 to the fabrication container 120, and forms a new powder layer on a fabrication surface including the solidified portion 110 and the unsolidified portion 111. Thereafter, the new powder layer is irradiated with the scanned laser beam 112 based on the slice data corresponding to a next layer. In the following, the solidified portion 110 corresponding to one layer of the slice data is referred to as a solidified layer, and an object obtained by stacking and integrating the solidified layers is referred to as a fabricated object in some cases.

The base plate 121 is made of a material that can be melted by the laser beam 112, such as stainless steel and ceramic. To melt and solidify the powder layer first formed on the base plate 121, the laser beam is applied under a condition that the surface of the base plate 121 is partially melted together with the raw material powder 106, and a first solidified layer and the base plate 121 are joined. A second and subsequent powder layers formed on the fabrication surface including the solidified portion 110 are preferably irradiated with the laser beam under a condition that a solidified layer to be newly formed and the solidified portion 110 previously formed are joined. When fabrication is performed such that the solidified layer to be newly formed and the solidified portion 110 previously formed are joined, the fabricated object is fixed to the base plate 121 as a result, which suppresses positional displacement of the fabricated object during fabrication. After fabrication is completed, the base plate 121 is mechanically separated from the fabricated object.

In the above-described manner, the step of laying the raw material powder on the fabrication surface (step of forming powder layer) and the step of irradiating the raw material powder with the scanned laser beam 112 are repeated a plurality of times, which makes it possible to manufacture the fabricated object (three-dimensional object) in which the solidified layers are integrated.

Next, a method of manufacturing an article containing silicon carbide as a main component by using silicon carbide powder as the raw material powder 106 will be described in detail.

In the powder bed fusion, powder containing 95 mol % or more of the silicon carbide was used, and a condition enabling stable fabrication was examined. To thermally decompose silicon carbide into silicon and carbon and to turn decomposed silicon or carbon into melt, various parameters were examined and the following findings were obtained.

The raw material powder used in the present invention contains 95 mol % or more of silicon carbide, preferably contains 98 mol % or more of silicon carbide, and more preferably contains 99 mol % or more of silicon carbide. Such silicon carbide powder is widely distributed as a commercial product, and is available at a low cost. Therefore, as compared with an existing technique in which a binder material is added, a fabrication cost can be reduced. When the powder having a high rate of silicon carbide is used as the raw material, a component rate of silicon carbide contained in an obtained three-dimensional object can be increased, and physical property can be brought close to physical property of a silicon carbide article fabricated by an existing firing method.

An average particle diameter of silicon carbide particles configuring the raw material powder 106 is preferably 0.5 μm or more and 200 μm or less, and more preferably 1 μm or more and 70 μm or less. If the average particle diameter of the silicon carbide particles is within the range, particle flowability suitable for densely laying the powder can be obtained, and a fine fabricated object can be fabricated. The average particle diameter used herein means a median diameter.

As a method of controlling irradiation energy of a laser beam, a method of controlling in-plane energy density and a method of controlling spatial energy density are usable. The in-plane energy density is irradiation intensity of the laser beam per unit area, and is represented by unit of J/mm 2. The spatial energy density is irradiation intensity of the laser beam per unit volume, and is represented by unit of J/mm³. In a case where a fabricated object is formed by controlling a thickness of the raw material powder as in the powder bed fusion, consideration of the spatial energy density is suitable. Spatial energy density J_{V} is represented by the following expression,

J_{V}=W/(P×V×D).

In the expression, W is output power of the laser beam, P is an irradiation pitch (scanning interval) of the laser beam, V is a scanning speed of the laser beam, and D is a thickness of a powder layer. In a common fabrication apparatus, the laser power W can be adjusted within a range of 10 W to 1000 W, the irradiation pitch P of the laser beam can be adjusted within a range of 5 μm to 500 μm, the scanning speed of the laser beam can be adjusted within a range of 10 mm/sec to 10000 mm/sec, and the thickness D of the powder layer can be adjusted within a range of 5 μm to 500 μm. Setting the parameters W, P, V, and D with the above-described ranges as rough indications makes it possible to control the spatial energy density J_{V}.

To stably perform fabrication using the silicon carbide powder, reduction of temperature unevenness occurring in a laser irradiated region is important. Thus, the laser beam is applied while a scanning method and a temperature profile in an irradiation spot are controlled, in addition to control of the spatial energy density J_{V}.

A preferred scanning method will be described. When scanning with the laser beam is continuously performed from an end by a single stroke corresponding to a shape of a fabricated object, irradiation heat is accumulated at a turnaround point, and a temperature is locally increased. As a result, a composition of the fabricated object is varied, and the number of voids is increased. However, when the laser beam is discretely applied, local temperature increase can be suppressed, and irradiation heat can be uniformized in a fabrication plane.

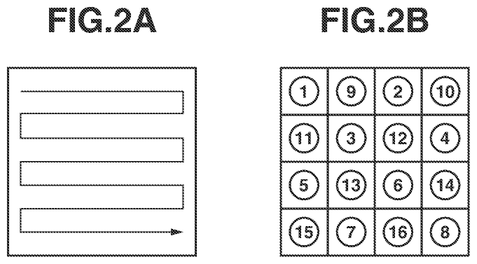

More specifically, as illustrated in FIG. 2B, an irradiation region is divided into rectangular regions, and the rectangular sections are discretely irradiated with the laser beam. An irradiation order is illustrated in each of the rectangular sections. The irradiation region preferably has a rectangular shape in which a length of one side is 1 mm or more and 5 mm or less, and an area is 1 mm² or more and 25 mm² or less. The irradiation region does not necessarily have a rectangular shape, and may have a polygonal shape, a circular shape, or a combination thereof as long as the area of the irradiation region is 1 mm² or more and 25 mm² or less; however, a plane can be preferably filled with a combination of one or a plurality of types of shapes.

In a case where the irradiation region is divided into the rectangular regions, a size of each of the rectangular regions is preferably 5 mm×5 mm or less, and more preferably 2 mm×2 mm or less.

Next, control of the temperature profile in the irradiation spot will be described. The temperature profile in the irradiation spot can be adjusted by a defocus state of the laser beam to be applied to the powder. When the defocus state is appropriately adjusted, temperature unevenness in the laser beam irradiation region can be reduced.

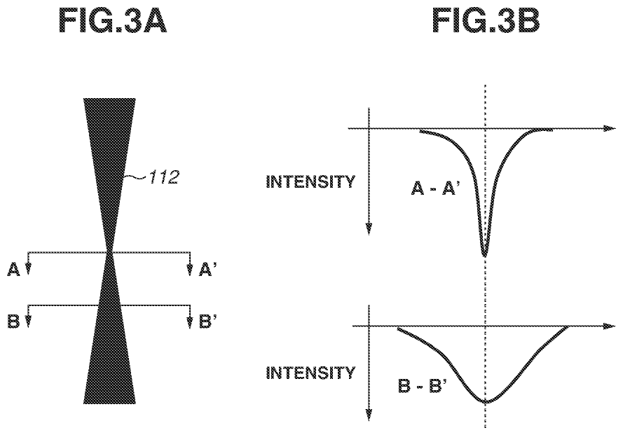

The temperature profile in the laser beam irradiation spot has a correlation with light intensity distribution in the irradiation spot. The light intensity distribution in the irradiation spot is Gaussian distribution in which the light intensity is lowered from a center of the spot to a periphery. A focus state and the defocus state will be described with reference to conceptual diagrams in FIG. 3A and FIG. 3B. The focus state indicates a state where the laser beam is focused on a surface of the laid powder, and the defocus state indicates a state where the laser beam is not focused on the surface of the laid powder. The defocus state is a state where a focal position estimated from a focal length of a condensing optical system of the used apparatus is deviated from the surface of the laid powder.

The light intensity distribution at the focus position (cross-section taken along line A-A′ in FIG. 3A) of the laser beam 112 is steep Gaussian distribution as illustrated in an upper part in FIG. 3B. In contrast, the light intensity distribution at the defocus position (near cross-section taken along line B-B′ in FIG. 3A) of the laser beam 112 is gentle as compared with the light intensity distribution at the focus position, as illustrated in a lower part in FIG. 3B.

As described above, at the focus position, in particular, difference of the light intensity between the center portion and the peripheral portion of the irradiation spot is large. Therefore, when the raw material powder is irradiated with the laser beam in the focus state, large temperature gradient occurs in the irradiation region, and the raw material powder is not uniformly melted. More specifically, even when the temperature at the peripheral portion of the irradiation spot can be adjusted to the temperature at which silicon carbide is decomposed into carbon and silicon, and silicon is melted, the temperature at the center portion is increased to the temperature at which silicon carbide sublimes, and fabrication cannot be performed. However, when the raw material powder is irradiated with the laser beam in the defocus state, the temperature gradient in the irradiation spot can be reduced, and the temperature of the entire irradiation spot can be adjusted to the temperature at which silicon carbide is decomposed into carbon and silicon, and silicon is melted. As described above, the temperature range at which silicon carbide can be decomposed into carbon and silicon, and silicon can be melted is 2830° C. or more and 3600° C. or less. Therefore, the light intensity distribution in the irradiation spot is preferably adjusted such that a difference between the maximum temperature and the minimum temperature in the irradiation spot becomes 770° C. or less, more preferably 500° C. or less, and still more preferably 400° C. or less.

As the method of adjusting the temperature profile in the irradiation spot, the method of applying the laser beam in the defocus state is described; however, the method is not limited thereto. For example, light intensity may be adjusted to distribution of a top hat shape or a donut shape by using a beam shaping element, and the raw material powder may be irradiated with the adjusted light beam.

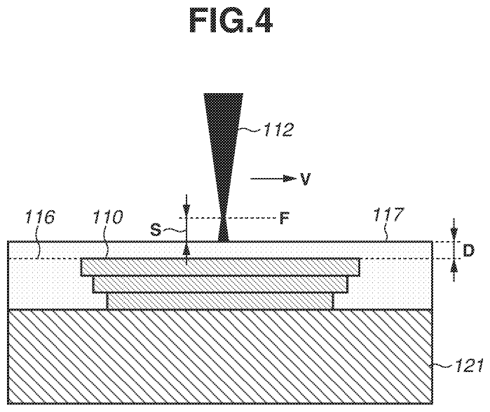

FIG. 4 illustrates a state where a powder layer 117 is irradiated with the laser beam 112 in the defocus state. In FIG. 4, a focus position F is deviated on a side opposite to a fabrication surface 116 from a surface of the powder layer 117.

As a defocusing method, two patterns of a case where the focus position F of the laser beam 112 is deviated on a side opposite to the fabrication surface 116 from the surface of the powder layer 117 and a case where the focus position F of the laser beam 112 is deviated toward the fabrication surface 116 from the surface of the powder layer 117 are considered. When the laser beam 112 is applied while the focus position F of the laser beam 112 is deviated toward the fabrication surface 116 from the surface of the powder layer 117, the temperature of the solidified portion 110 and the raw material powder below the powder layer may be increased to 3600° C. or more. In such a case, powder scattering occurs due to sublimation of silicon carbide, which may generate voids in the solidified portion or form a solidified portion not based on the slice data.

Thus, when the powder layer 117 is irradiated with the laser beam 112 in the defocus state, the optical system is adjusted such that the focus position F of the laser beam 112 is deviated above the surface of the powder layer 117, namely, on the side opposite to the fabrication surface 116 from the surface of the powder layer 117, as illustrated in FIG. 4. When a distance (defocus amount) S between the focus position F and the surface of the powder layer 117 is excessively small, the temperature gradient in the irradiation region cannot be reduced, and bumping caused by the powder melt easily occurs. When the defocus amount S is excessively large, high output power is necessary, or irradiation energy is insufficient, and the powder is not melted and fabrication cannot be performed. Even depending on the optical system of the used fabrication apparatus, to adjust the temperature profile in the irradiation spot of a YAG laser by the defocus amount, the defocus amount S is preferably set to 5 mm or more and 10 mm or less.

When the laser beam 112 is applied while the focus position F of the laser beam 112 is deviated on the side opposite to the fabrication surface 116 from the surface of the powder layer 117, the temperature of the powder on the surface side is increased. As a result, thermal decomposition occurs mainly on the surface side, silicon melt or carbon melt is generated, and the powder on the fabrication surface 116 side maintains the state of silicon carbide. According to the method, it is possible to selectively melt a surface portion of the powder layer 117 to cause thermal decomposition of silicon carbide and to generate melt while suppressing excess decomposition of the silicon carbide powder, thereby performing fabrication by the silicon carbide powder.

To form one fabricated object by stacking a plurality of solidified layers, it is necessary to join a solidified layer previously formed and a solidified layer subsequently formed. To join the solidified layers, the silicon melt or the carbon melt generated by irradiation with the laser beam is preferably infiltrated up to a vicinity of a surface of the solidified layer previously formed. Such a state can be realized by adjusting the thickness of the powder layer 117 to be formed. Although it may depend on the fabrication condition, as a result of examination by the present inventors, the thickness of the powder layer 117 at which fabrication can be performed while the melt of thermally decomposed silicon is infiltrated up to the vicinity of the surface of the solidified layer previously formed to join the solidified layers is 5 μm or more and 200 μm or less. More preferably thickness of the powder layer 117 is 20 μm or more and 75 μm or less.

In a case of using the base plate 121 excellent in thermal conductivity, at the beginning of fabrication, heat is diffused to the periphery via the base plate 121, the temperature of the powder cannot be sufficiently increased, and the solidified portion 110 is difficult to be joined to the base plate 121. When fabrication progresses and the height of the fabricated object is increased, diffusion of heat via the base plate 121 is reduced. However, the fabricated object is buried in the silicon carbide powder high in thermal conductivity, heat escapes via the silicon carbide powder, and the powder at the laser beam irradiation portion cannot be sufficiently increased.

To eliminate such a state, a configuration for preventing the temperature of the powder at the laser beam irradiation portion from lowering is preferably added to the fabrication apparatus 100. For example, a heating mechanism is preferably provided on the fabrication container 120 to preheat the whole inside of the fabrication container 120. The heating mechanism preferably heats the solidified portion (fabricated object) 110 and the powder of the unsolidified portion 111 to 30° C. or more and 100° C. or less. More specifically, a heater is preferably installed around the fabrication container 120. Alternatively, a laser for preheating is preferably installed separately from the laser for melting the powder, thereby locally heating the powder around the laser beam irradiation portion. In a case where a preheating temperature is less than 30° C., heat may be diffused at the time of laser beam irradiation and the raw material powder cannot be sufficiently melted, a space is generated between the base plate 121 and the solidified portion 110 or between the solidified portion 110 and the solidified layer stacked thereon, and peeling may occur as a result. When the preheating temperature exceeds 100° C., the raw material powder tends to be easily aggregated.

The fabricated object obtained by the above-described process contains silicon carbide as unmelted raw material powder, and carbon and silicon decomposed from silicon carbide. If the fabricated object contains carbon and silicon, the fabricated object has physical properties lower than physical properties of a fired product of existing silicon carbide powder. To improve the physical properties derived from carbon and silicon contained in the fabricated object, the fabricated object is preferably subjected to heat treatment so as to change carbon and silicon into silicon carbide.

It is known that, although a melting point of silicon is 1414° C., when silicon and carbon are mixed and heat treatment is performed at 1300° C., reaction occurs to generate silicon carbide. To promote reaction of silicon and carbon while suppressing evaporation of silicon generated by decomposition of silicon carbide, the temperature of heat treatment performed after fabrication is preferably 1300° C. or more and 2000° C. or less, and more preferably 1300° C. or more and 1700° C. or less.

When a composition of the fabricated object fabricated by being irradiated with the laser beam in the defocus state is evaluated in a stacking direction by Raman spectroscopy, a region where a composition ratio of silicon, carbon, and silicon carbide periodically changes in one direction based on a stacking pitch of the solidified layers is observed. More specifically, in a region corresponding to one solidified layer of the fabricated object, silicon and carbon are largely detected and a detection amount of silicon carbide is small at one of ends in a thickness direction, whereas a detection amount of each of silicon and carbon is small and the detection amount of silicon carbide is large at the other end.

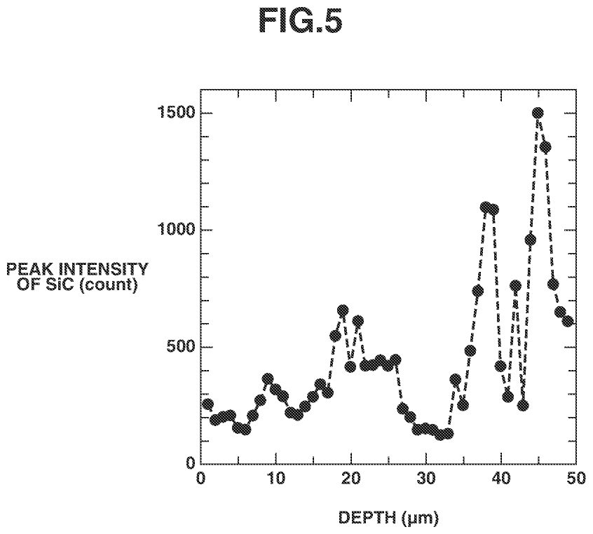

FIG. 5 illustrates relationship between a depth from a surface of a fabricated object fabricated while the powder layer is formed with a thickness of 50 μm and peak intensity of silicon carbide in Raman spectroscopy. The depth on a lateral axis indicates a depth from a finally fabricated surface of the fabricated object (a surface on the side opposite to the base plate). It can be seen from the drawing that little silicon carbide is present near the surface, but silicon carbide is largely present as the depth from the surface is increased. The result corresponds to estimation that silicon carbide on the surface portion of the powder layer is thermally decomposed and silicon or carbon is turned into melt by irradiation with the laser beam in the defocus state, and a part of the melt is infiltrated up to the vicinity of the surface of the solidified layer previously formed in the gravity direction.

The fabricated object fabricated by the method according to the present invention internally includes voids. Therefore, impregnation is preferably performed to further improve density depending on application. As a method of impregnation, solid-phase impregnation, liquid-phase impregnation, and vapor-phase impregnation are known. Among them, solid-phase impregnation and liquid-phase impregnation are preferable because solid-phase impregnation and liquid-phase impregnation can relatively easily enhance density of the fabricated object and enhance mechanical strength. In particular, solid-phase impregnation is preferable because solid-phase impregnation can improve density in a short time. In a case where density of the fabricated object is improved by impregnation, heat treatment after impregnation described below can serve as the above-described heat treatment.

In a case where solid-phase impregnation is performed on the fabricated object containing silicon carbide as a main component, the voids in the fabricated object are preferably turned into silicon carbide by causing the voids to carry carbon and then to absorb melted silicon. In a specific procedure of solid-phase impregnation, first, the fabricated object is immersed in a liquid resin, and is then defoamed in a vacuum to impregnate the voids with the liquid resin. After an excess liquid resin on the surface of the fabricated object is removed, the resin is cured by heating and is further heated to carbonize the resin. This causes the voids to carry carbon. Subsequently, the resultant fabricated object is brought into contact with melted silicon in a vacuum to impregnate the voids with silicon, and is heated at 1450° C. or more and 1700° C. or less, thereby turning the voids into silicon carbide. A vacuum degree during impregnation of silicon is preferably 500 Pa or more and 50000 Pa or less, more preferably 1000 Pa or more and 10000 Pa or less, and still more preferably 1000 Pa or more and 5000 Pa or less. After the voids are turned into silicon carbide, excess silicon is adhered onto the surface of the object, but can be removed by post-processing such as polishing and etching.

As the resin used to cause the voids in the fabricated object to carry carbon, a resin containing no metal components is used. If the resin contains metal components, the metal components react with silicon in the fabricated object to generate excess silicide compounds. A percentage of silicon carbide in the voids can be enhanced as a residual carbon percentage in the resin is high.

The residual carbon percentage in the resin is preferably 50% or more, more preferably 60% or more, and especially preferably a phenol resin.

To cause the resin to permeate into the voids, viscosity of the resin is preferably 1000 mPa·s or less, and more preferably 500 mPa·s.

In a case where liquid-phase impregnation is performed on the fabricated object containing silicon carbide, commercially available silicon carbide polymer (for example, SMP-10 available from Starfire Systems, Inc.) can be used as an impregnation material. The fabricated object is immersed in a liquid of silicon carbide polymer, and is then defoamed in a vacuum to introduce the liquid of silicon carbide polymer into the voids of the fabricated object. After an excess liquid is removed from the surface of the fabricated object, heat treatment is performed at 400° C. or more and 850° C. or less in inert gas, to turn silicon carbide polymer into an inorganic substance. Silicon carbide polymer is a silicon carbide ceramic precursor containing an organic substance. Therefore, about 30 wt. % of silicon carbide polymer is lost due to volatilization by heat treatment. Accordingly, a void percentage of the fabricated object can be reduced by repeating the impregnation and heat treatment step a plurality of times. Silicon carbide obtained by performing heat treatment on silicon carbide polymer at 400° C. or more and 850° C. or less has an amorphous structure. As necessary, heat treatment is performed at 1500° C. or more and 1600° C. or less later to crystallize silicon carbide, which makes it possible to improve characteristics.

The fabricated object subjected to impregnation is further subjected to post-processing such as polishing and cutting as necessary, thereby being turned into an article containing silicon carbide as a main component.

### Examples

Examples according to the present invention will be described. However, kinds, compositions, particle sizes, and shapes of powders, laser power, and the like described below should be appropriately changed depending on a configuration of an apparatus to which the invention is applied and various kinds of conditions, and are not intended to limit the invention to the disclosed scope of the present specification.

First, relationship between irradiation requirements of the laser beam and the temperature of the laser beam irradiation portion was examined.

The silicon carbide powder (98.7 mol % of silicon carbide) having an average particle diameter of 14.7 μm was laid at a thickness of 50 μm over the base plate 121, and the powder was irradiated with a laser beam while a defocus amount and spatial energy density were changed. A temperature of a melt pool formed at the laser beam irradiation portion was measured by a high-speed radiation pyrometer (model number: Metic M311) and evaluated. Table 1 illustrates results. The spatial energy density illustrated in Table 1 was spatial energy density at a focal position of the laser beam and was calculated from an expression J_{V}=W/(P×V×D). Evaluation criteria were as follows.
A: The entire temperature was within a range of 2830° C. or more and less than 3600° C.
B: The entire temperature was 2830° C. or more, and partially 3600° C. or more
C: The entire temperature was less than 3600° C., and partially less than 2830° C.
D: The entire temperature was 3600° C. or more
E: The entire temperature was less than 2830° C.

TABLE 1

| Laser beam | Defocus | | | | | | |
|---|---|---|---|---|---|---|---|
| irradiation | amount S | Spatial energy density J_{V} [J/cm³] | | | | | |
| condition | [mm] | 20 | 25 | 30 | 35 | 40 | 45 |
| 1 | 4 | D | B | B | B | D | D |
| 2 | 5 | D | A | B | B | B | D |
| 3 | 6 | D | A | A | B | B | B |
| 4 | 7 | C | A | A | A | B | B |
| 5 | 8 | E | A | A | A | B | B |
| 6 | 9 | E | E | E | E | E | E |

Next, fabrication was performed under the laser beam irradiation conditions illustrated in Table 1 by using the same silicon carbide powder as the raw material powder.

The base plate 121 made of stainless steel was placed on the stage 108. After the raw material powder 106 was contained in the powder container 122 and the chamber 101 was evacuated to a vacuum, a step of introducing Ar gas was performed a plurality of times to replace the inside of the chamber 101 with an Ar atmosphere. A heater was provided on the fabrication container 120 and was set to 40° C. to preheat the raw material powder 106 and the base plate 121.

Subsequently, fabrication operation was performed based on slice data generated from a fabrication model of a cube having a size of 5 mm×5 mm×5 mm. First, a step of adjusting the height of the stage 108, and supplying the raw material powder in the powder container 122 onto the stage 108 by the powder laying mechanism 107, to form a powder layer having a thickness of 50 μm on the base plate 121 was performed. Thereafter, a step of irradiating the powder layer with the laser beam was performed.

The defocus amount S of the laser beam 112 was adjusted by vertically moving the stage. An Nd:YAG laser having a wavelength of 1060 nm was used as a laser light source. The laser power was fixed to 100 W, the pitch was fixed to 40 μm, and the scanning speed was adjusted within a range of 1111 mm/sec to 2500 mm/sec to change the spatial energy density. After irradiation of the first layer with the laser beam was completed, the step of forming a powder layer and the step of irradiating the powder layer with the laser beam were alternately repeated 100 times to obtain a fabricated object.

To firmly join the solidified portion to the base plate 121, first to third layers were fabricated at the spatial energy density of 50 J/mm³ under all conditions.

The laser beam was discretely applied. More specifically, the irradiation region was set to a square shape having a side length of 1 mm, and adjacent irradiation regions were overlapped by 0.1 mm such that a distance between centers of adjacent squares became 0.8 mm. Out of two solidified layers successively formed, a solidified layer subsequently formed was rotated by 18 degrees in a fabrication plane while the irradiation region was parallelly moved in a fixed direction by 0.25 mm in the fabrication plane, relative to a solidified layer previously formed. By the devisal, temperature uniformity in the fabrication plane was secured, and a fabricated object relatively high in strength was obtainable.

Note that fabrication was previously performed without performing parallel movement and rotation of the irradiation region in the fabrication plane. As a result, the obtained fabricated object was in a state where square poles formed by stacking the solid layers in a square shape having a side length of 1 mm were arranged side by side, joining force between the square poles was weak, and the fabricated object tended to be easily damaged.

The state of the obtained fabricated object was evaluated. Table 2 illustrates results. Evaluation criteria were as follows.
A: The fabrication accuracy in the height direction was 90% or more
B: The fabrication accuracy in the height direction was 80% or more and less than 90%
C: The fabrication accuracy in the height direction was less than 80%
D: An object could not be fabricated

TABLE 2

| Laser beam | Spatial energy density J_{V} [J/cm³] | | | | | |
|---|---|---|---|---|---|---|
| irradiation condition | 20 | 25 | 30 | 35 | 40 | 45 |
| 1 | C | B | B | B | C | C |
| 2 | C | A | B | B | B | C |
| 3 | C | A | A | B | B | B |
| 4 | A | A | A | A | B | B |
| 5 | C | A | A | A | B | B |
| 6 | D | D | D | D | D | D |

In Table 1, under the condition that the temperature of the entire melt pool was settled within a range of 2830° C. or more and less than 3600° C., the fabricated object can be obtained with excellent accuracy relative to the three-dimensional model. Under the condition that the temperature of the entire melt pool was 2830° C. or more and partially 3600° C. or more, a part of melted silicon or carbon was evaporated, and accuracy in the height direction was accordingly slightly lowered. Under the condition that the temperature of the entire melt pool was less than 3600° C. and partially less than 2830° C., evaporation of melted silicon or carbon was suppressed, the solidified portion was formed by infiltration of melted silicon or carbon, and the fabricated object with high accuracy was obtained. Under the condition that the temperature of the entire melt pool was 3600° C. or more, silicon carbide sublimed and scattering of the powder was observed, and accuracy in the height direction of the obtained fabricated object was 80% that was low. Under the condition that the temperature of the entire melt pool was less than 2830° C., decomposition of silicon carbide did not occur, and fabrication could not be performed.

When the fabricated objects having excellent evaluation result like A or B were observed under a microscope, voids were observed. Thus, solid-phase impregnation was performed on the fabricated objects. A sufficient amount of liquid phenol resin (PR-50607B available from Sumitomo Bakelite Co., Ltd.) was dropped onto the fabricated object, and then the fabricated object was defoamed in a vacuum. After an excess phenol resin on the surface of the fabricated object was wiped off, the fabricated object was heated at 160° C. on a hot plate to thermally cure the phenol resin.

Thereafter, the fabricated object was separated from the base plate by using a diamond wire saw. When a cross-sectional surface of the fabricated object impregnated with the phenol resin was observed under the microscope, a state where the phenol resin sufficiently penetrated into the voids was confirmed. The fabricated object did not chip when the fabricated object was separated from the base plate.

The fabricated object impregnated with the phenol resin was immersed into liquid phenol resin, was defoamed in a vacuum, and was impregnated again. After impregnation with the phenol resin, a volume and a weight of the fabricated object were measured, and the void percentage was calculated. The amount of silicon necessary for impregnation was calculated from a result of the calculated void percentage. Alumina balls each having a diameter of 2 mm were laid as a setter on a bottom of a crucible made of alumina, and the fabricated object was placed in the crucible so as not to come into tight contact with the crucible. An amount of silicon pieces or silicon powder that was about 20% greater than the calculated necessary amount of silicon was placed on the fabricated object, followed by heat treatment. The heat treatment was performed at 1500° C. for 1 hour in an Ar atmosphere with a pressure of 2600 Pa. As a result, an article was obtained.

As a result of observation of the structure under the microscope, it was confirmed that the obtained article was sufficiently dense, and it was confirmed from evaluation of the physical properties that the obtained article had characteristics sufficient as a silicon carbide product.

The present invention is not limited to the above-described exemplary embodiment, and can be variously changed and modified without departing from the spirit and the scope of the present invention. Accordingly, the following claims are attached in order to make the scope of the present invention public.

According to the present invention, it is possible to manufacture an article containing silicon carbide as a main component with high accuracy at a low cost by using powder bed fusion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A method of manufacturing an article containing silicon carbide as a main component, the method comprising:
a step of laying a powder; and
a step of melting the powder,
wherein the powder contains 95 mol % or more of silicon carbide, and
wherein, in the step of melting the powder, the silicon carbide decomposes into silicon and carbon, and at least one of the silicon and the carbon melt.

2. The method of manufacturing an article according to claim 1, wherein, in the step of melting the powder, the silicon carbide is controlled to a temperature of 2830° C. or more and less than 3600° C.

3. The method of manufacturing an article according to claim 1, wherein, in the step of melting the powder, a plurality of regions of the powder is discretely irradiated with a laser beam.

4. The method of manufacturing an article according to claim 3, wherein an area of one of the plurality of regions is 1 mm² or more and 25 mm² or less.

5. The method of manufacturing an article according to claim 1, wherein, in the step of melting the powder, the powder is irradiated with a laser beam to cause a focus position of the laser beam to be positioned above a surface of the powder.

6. The method of manufacturing an article according to claim 5, wherein a distance between the focus position of the laser beam and the surface of the powder is 5 mm or more and 10 mm or less.

7. The method of manufacturing an article according to claim 1, wherein heating is performed to cause a temperature of a base plate on which the powder is laid and a temperature of the powder to be 30° C. or more and 100° C. or less.

8. The method of manufacturing an article according to claim 1, further comprising a step of performing heat treatment on a fabricated object obtained by repeating the step of laying the powder and the step of melting the powder,
wherein, in the step of performing heat treatment, heating is performed at 1300° C. or more and 2000° C. or less.

9. The method of manufacturing an article according to claim 8, further comprising, before the step of performing heat treatment:
a step of impregnating the fabricated object with a resin, and then heating the fabricated object until the resin is carbonated; and
a step of impregnating the fabricated object with melted silicon,
wherein, in the step of performing heat treatment, heating is performed at 1450° C. or more and 1700° C. or less.

10. The method of manufacturing an article according to claim 9, wherein the resin contains no metal components.

11. The method of manufacturing an article according to claim 10, wherein the resin is a phenol resin.

12. The method of manufacturing an article according to claim 1, further comprising:
a step of impregnating, with silicon carbide polymer, a fabricated object obtained by repeating the step of laying the powder and the step of melting the powder; and
a step of heating the fabricated object impregnated with the silicon carbide polymer at 400° C. or more and 850° C. or less.

13. The method of manufacturing an article according to claim 12, further comprising a step of heating the fabricated object at 1500° C. or more and 1600° C. or less.

14. The method of manufacturing an article according to claim 1, wherein the powder contains 99 mol % or more of silicon carbide.

15. The method of manufacturing an article according to claim 1, wherein an average particle diameter of the powder is 0.5 μm or more and 200 μm or less.

16. The method of manufacturing an article according to claim 1, wherein the step of melting the powder is performed by irradiating a portion of the powder with a laser beam for a time of millisecond order.

17. The method of manufacturing an article according to claim 1, further comprising a step of generating silicon carbide from the silicon and the carbon.

18. An article containing silicon carbide as a main component and including a region where a composition ratio of silicon, carbon, and silicon carbide changes in one direction.

19. The article according to claim 18, wherein the region is periodically included.

20. The article according to claim 19, wherein the region has a thickness of 5 μm or more and 200 μm or less.
